(19) United States
(12) Patent Application Publication
(10) Pub. No.: US 2025/0332484 A1
(43) Pub. Date: Oct. 30, 2025

(54) BALL WITH FILTER

(71) Applicant: Double G Games LLC, Plymouth, MN (US)

(72) Inventors: Gary Graham, Plymouth, MN (US); Dan Cook, Amelia Island, FL (US)

(21) Appl. No.: 19/190,924

(22) Filed: Apr. 28, 2025

Related U.S. Application Data
(60) Provisional application No. 63/640,272, filed on Apr. 30, 2024.

(51) Int. Cl. A63B 43/00; B01D 35/157

(52) U.S. Cl. CPC A63B 43/002; B01D 35/157

(57) ABSTRACT

A ball comprises a shell portion and a filter portion. The filter portion regulates gaseous material exchange and internal pressure of the ball. The shell portion comprises a non-porous material. Solid material such as sand, salt, flour, glass, or magnetic beads are used as filler material within the shell portion to precisely adjust the weight of the ball, allowing for tailored performance characteristics suitable for various applications.

### CROSS REFERENCE TO RELATED APPLICATION(S)

This claims priority to U.S. Provisional Application No. 63/640,272, filed on Apr. 30, 2024, entitled BALL WITH FILTER, the disclosure of which is hereby incorporated by reference in its entirety.

### BACKGROUND

The development of specialized game equipment often seeks to enhance the versatility and functionality of items used in sports, recreational, and therapeutic contexts. Traditional balls used in various games and physical therapy lack customization options that cater to different environmental conditions and specific user needs. There has been a significant need for a ball that is adaptable in weight and usability across different types of game surfaces, including flat or inclined fields.

Furthermore, current offerings do not always provide for a quick and efficient means of adjusting ball characteristics, such as weight, to alter game difficulty or to suit therapeutic needs. Additionally, the process of filling balls with various materials can be cumbersome and time-consuming without the aid of appropriate technology.

### SUMMARY

This disclosure broadly relates to a ball with filter. In some examples, the weight of the ball is customizable such that the ball may be utilized in a variety of applications, such as, for example, recreational or therapeutic applications.

In some examples, the ball is filled with both solid material and gaseous material, such as air. A filter may be provided to permit the transmission of gaseous material into and out of the ball while simultaneously restricting transmission of solid material.

In some examples, a ball comprises a shell portion comprising a flexible outer surface and an inner sleeve. The shell portion defines an inner cavity of the ball. A filter portion is arranged in the inner sleeve. The filter portion is configured to permit transmission of gaseous material and block transmission of solid material into and out of the inner cavity. A solid material is arranged within the inner cavity.

### BRIEF DESCRIPTION OF THE DRAWINGS

FIG. 1 is a perspective view of an example ball.

FIG. 2 is a perspective view of an example shell portion of the ball of FIG. 1.

FIG. 3 is a cross sectional view of the shell portion of FIG. 2.

FIG. 4 is a perspective view of an example filter portion of the ball of FIG. 1.

FIG. 5 is a cross sectional view of the filter portion of FIG. 4.

FIG. 6 is a cross sectional view of the example ball of FIG. 1.

FIG. 7 is a schematic view of an example ball filling station.

FIG. 8 is a perspective view of another example ball filling station.

FIG. 9 is a perspective view of a portion of the example ball filling station of FIG. 8.

FIG. 10 is a side view of an example game board equipped with an example game board accessory.

FIG. 11 is another side view of the game board and game board accessory of FIG. 10.

FIG. 12 is a front view of the game board and game board accessory of FIG. 10.

FIG. 13 is a side view of the game board of FIG. 10 and another example game board accessory.

### DETAILED DESCRIPTION

This disclosure is directed to an example ball and methods of manufacturing the ball. In some example, the ball comprises an outer shell and is filled with air and filler material.

In some examples, the ball is customizable such that ball characteristics, such as weight can be adjusted. In some examples, the ball comprises a filter that allows for rapid adjustment of air flow to prevent overinflation and enhances the ability of a rolling or bouncing ball to stop on the playing surface. In some examples, the use of non-porous materials for the ball's outer shell, coupled with a filter system capable of incorporating either mechanical or porous media, facilitates the control of air and filler material flow, enhancing the ball's utility and performance.

In some examples, the disclosure is further directed to a mechanical system for filling the ball with filler material. In some examples, the mechanical system for filling the ball utilizes vibratory assistance to expedite the process of filling the ball with filler material.

In some examples, the disclosure is further directed to adjustable brackets used for modifying game boards that the ball can be used in conjunction with. In some examples, the adjustable brackets are used to modify the angle of the playing surface to accommodate different game dynamics.

### Ball

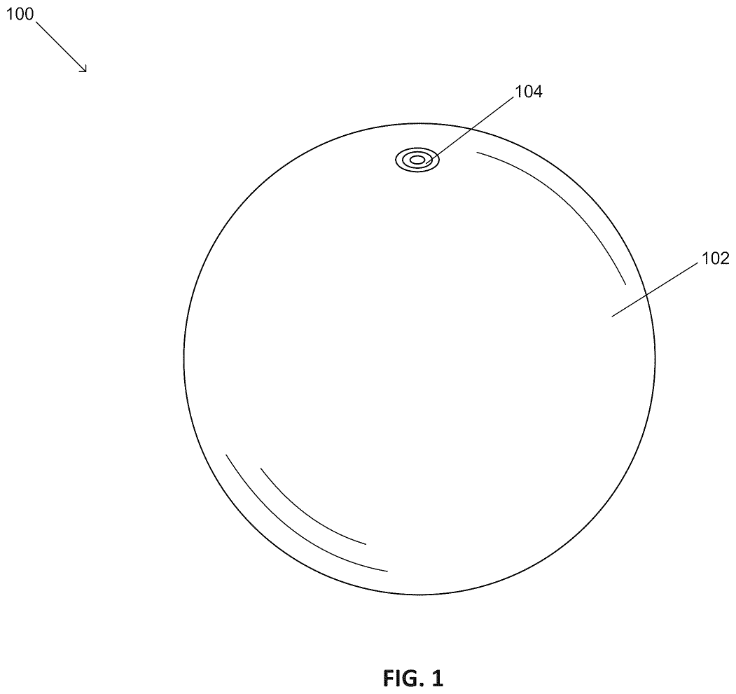

FIG. 1 is a perspective view of an example ball 100. In some examples, the ball 100 comprises a shell portion 102 and a filter portion 104. In some examples, the ball 100 is formed in a substantially spherical shape. In some examples, the filter portion 104 is inserted into the shell portion 102 at a point along the outer surface of the ball 100.

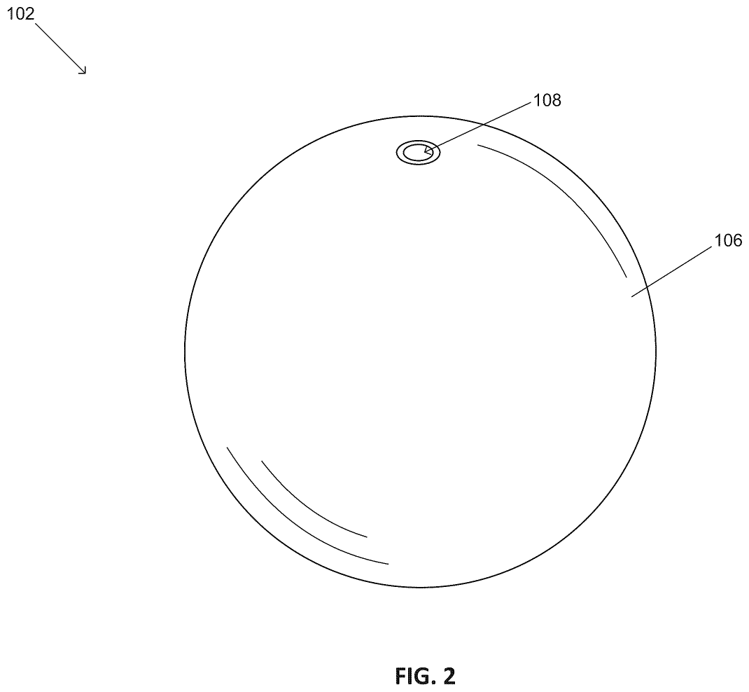

FIG. 2 is a perspective view of the shell portion 102 of the example ball 100. In some examples, the shell portion 102 comprises an outer surface 106 and a hole 108.

In some examples, the shell portion 102 is flexible. In some examples, the shell portion 102 comprises a material such as, for example, PVC, silicone, silicone rubber, TPU. In some examples, the material comprises other flexible material. In some examples, the material is chosen to enhance durability and suitability of the ball 100 for both indoor and outdoor use. For example, a waterproof material may be chosen to minimize egress of water into the interior of the ball 100 through the outer surface 106 of the shell portion 102 of the ball 100.

In some examples, the outer surface 106 may comprise various different textures. In some examples, the outer surface 106 features a rough textured surface to enhance grip during handling. In some examples, the outer surface 106 is textured so as to increase friction upon contact with a surface onto which the ball 100 is thrown, thereby aiding in control and placement. In some examples, the outer surface 106 comprises a smooth texture to minimize friction with a surface onto which the ball 100 is thrown, thereby increasing the challenge of landing accurately on the designated target surface.

In some examples, the outer surface 106 is colored and comprises, for example, a red or a blue color. In some examples, the outer surface 106 comprises a glow in the dark material. In some examples, the outer surface 106 includes various decorative markings arranged thereon, such as, for example, stars or stripes. In some examples, the outer surface 106 comprises a logo, website, or other indicia included thereon.

In some examples, the hole 108 is formed within the outer surface 106 of the shell portion 102 and extends through the outer surface 106 of the shell portion 102. In some examples, the hole 108 is approximately 0.19 inches in diameter, such as, for example, 0.19 inches in diameter. In other examples, the hole 108 is approximately 0.17 inches in diameter, such as, for example, 0.17 inches in diameter. In some examples, the hole 108 provides access through the outer surface 106 of the shell portion 102 into an interior space of the ball 100.

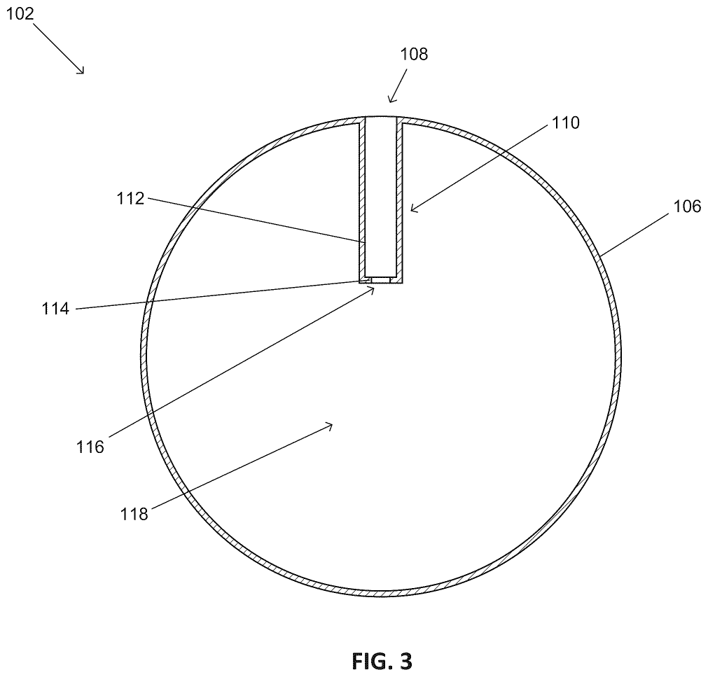

FIG. 3 is a cross sectional view of the example shell portion 102. In some examples, the shell portion 102 further includes a sleeve 110. In some examples, the sleeve 110 connects to an outer edge of the hole 108. In some examples, the sleeve 110 extends into an interior space of the ball 100. In some examples, the hole 108 provides access to the sleeve 110 from the outside of the ball 100. In some examples, the shell portion 102 defines an interior cavity 118 of the ball 100.

In some examples, the outer surface 106 extends around the outside of the shell portion 102. In some examples, the outer surface 106 is approximately 0.125 inches thick, such as, for example, 0.125 inches thick. In some examples, the outer surface 106 is approximately 3 inches in diameter, such as, for example, three inches in diameter.

In some examples, the sleeve 110 comprises an inner surface 112, a bottom surface 114, and a bottom hole 116. In some examples, the inner surface 112 extends into the interior cavity 118 from the hole 108 in the outer surface 106. In some examples, the diameter of the inner surface 112 is the same as the diameter of the hole 108. In some examples, the inner surface 112 extends approximately 1 inch into the interior cavity 118 from the outer surface 106 of the shell portion 102, such as, for example, 1 inch into the interior cavity 118. In some examples, the thickness of the inner surface 112 is substantially the same as the thickness of the outer surface 106.

In some examples, the bottom surface 114 connects to the cylindrical surface of the sleeve 110 at the innermost point of the inner surface 112. In some examples, the thickness of the inner surface 112 is substantially the same as the thickness of the outer surface 106.

In some examples, the bottom hole 116 is formed through the bottom surface 114 of the sleeve 110 and provides access into the interior cavity 118. In some examples, the bottom hole 116 is approximately 0.1 inches in diameter, such as, for example, 0.1 inches in diameter.

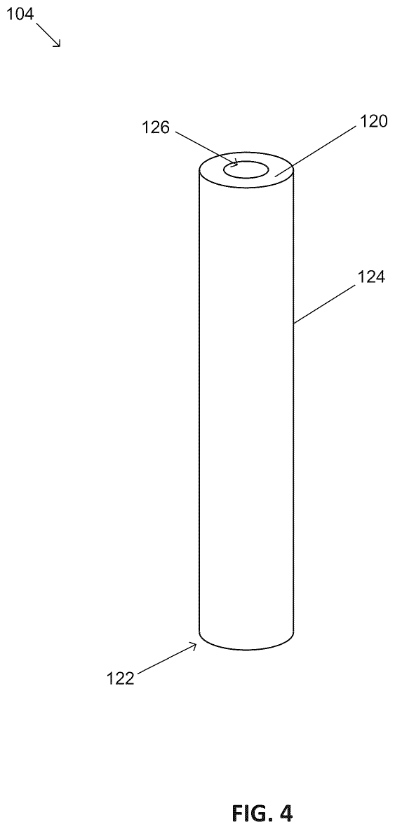

FIG. 4 is a perspective view of an example filter portion 104 of the ball 100 of FIG. 1. In some examples, the filter portion 104 comprises a top surface 120, a bottom surface 122, and an outer surface 124.

As shown in FIG. 4, in some examples, the filter portion 104 is cylindrical in shape. Thus, in some examples, the outer surface 124 comprises a cylinder. Similarly, in such examples, the top surface 120 and the bottom surface 122 are circular.

In some examples, the diameter of the filter portion 104 is approximately 0.190 inches in diameter, such as, for example, 0.190 inches in diameter. In some examples, the diameter of the filter portion 104 is approximately 0.195 inches in diameter, such as, for example, 0.195 inches in diameter. In some examples, the diameter of the filter portion 104 is approximately 0.170 inches in diameter, such as, for example, 0.170 inches in diameter. In some examples, the diameter of the filter portion 104 is approximately 0.175inches in diameter, such as, for example, 0.175 inches in diameter. In some examples, the diameter of the filter portion 104 is approximately 0.005 inches larger than the diameter of the hole 108 of the shell portion 102.

In some examples, the filter portion 104 further comprises a hole 126. In other examples, the filter portion 104 does not include the hole.

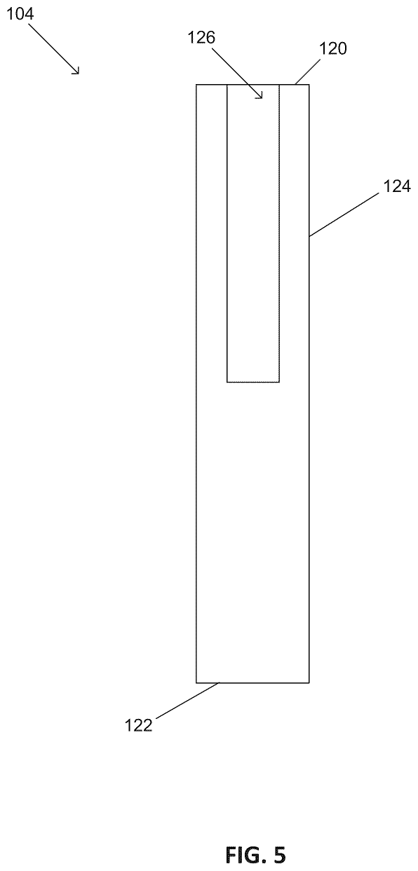

FIG. 5 is a cross sectional view of the filter portion 104 of FIG. 4. As shown in FIG. 5, in some examples, the hole 126 extends through the filter portion 104. In some examples, the hole extends partially through the filter portion 104. In some examples, the hole 126 is arranged in the top surface 120 and extends into the filter portion 104 from the top surface 120. In some examples, the hole 126 extends approximately 0.5 inches into the filter portion 104 from the top surface 120 of the filter portion 104, such as, for example. 0.5 inches into the filter portion 104. In some examples, the diameter of the hole 126 is approximately 0.09 inches, such as, for example, 0.09 inches.

In some examples, the filter portion 104 comprises a mechanical filter or filter, which permits air exchange through the filter portion 104. In some examples, the filter portion 104 comprises a filter made from porous media, such as, for example, synthetic fiber, polyester (such as, for example, extruded polyester), or foam (such as, for example, open-cell foam). In some examples, the filter portion 104 permits air flow but prevents the flow of solid materials such as dirt, or liquid material, such as water, through the filter portion 104.

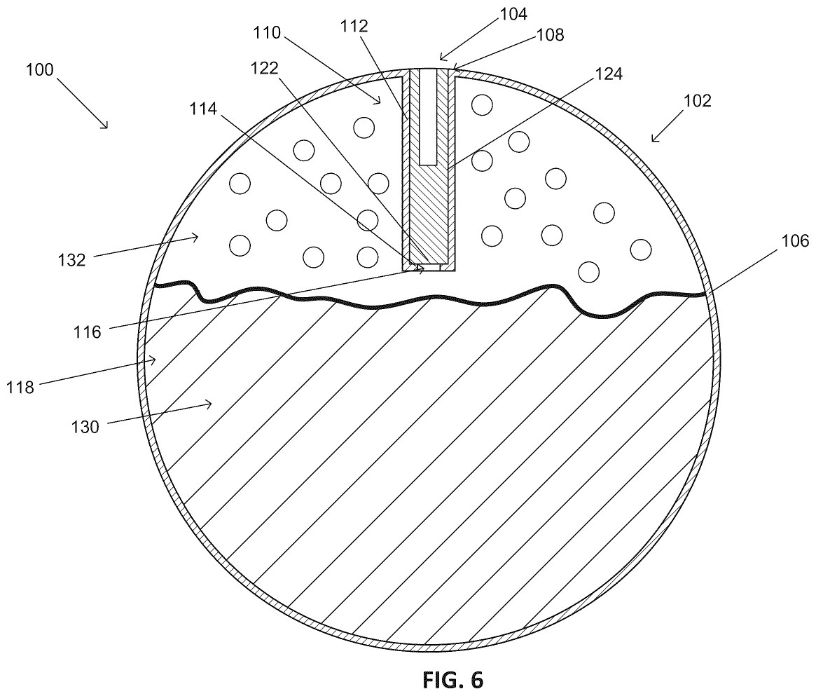

FIG. 6 is a cross sectional view of the ball 100 of FIG. 1. As shown in the example of FIG. 6, when assembled, the filter portion 104 is inserted into the sleeve 110 through the hole 108 of the shell portion 102.

Specifically, in some examples, the filter portion 104 is inserted into the sleeve 110 such that the outer surface 124 of the filter portion 104 contacts the inner surface 112 of the sleeve 110. In some examples, the filter portion 104 is placed into the sleeve 110 with a press fit, such as, for example, an interference fit. In some examples, the diameter of the outer surface 124 of the filter portion 104 is sized to be approximately. 005 inches greater than the diameter of the inner surface 112 of the sleeve 110 so as to provide an interference fit that retains the filter portion 104 within the sleeve 110. In some examples, the filter portion 104 is further held in place within the sleeve 110 using a glue that bonds the outer surface 124 of the filter portion 104 to the inner surface 112 of the sleeve 110.

In some examples, the bottom surface 122 of the filter portion 104 contacts the bottom surface 114 of the sleeve 110. In some examples, the bottom surface 122 of the filter portion 104 is placed over the bottom hole 116 of the sleeve 110. In some examples, the arrangement of the filter portion 104 over the bottom hole 116 provides control over the ingress and egress of material into and out of the interior cavity 118 of the ball 100.

In some examples, as shown in the example of FIG. 6, the ball 100 further comprises material arranged within the interior cavity 118 of the ball 100. For example, the interior cavity 118 of the ball 100 is filled with solid material 130 and gaseous material 132. In some examples, the gaseous material 132 comprises air. In some examples, the solid material 130 comprises, for example, on or more of: sand, salt, flour, glass, and plastic material. In some examples, the solid material 130 comprises organic materials like corn or beans. In some examples, the solid materials 130 comprises magnetic material, such as, for example, magnetic beads or particles. In some examples, use of magnetic material causes the ball to quickly stop rolling when thrown onto a magnetic surface.

In some examples, the amount of solid material 130 included within the ball 100 is selected to provide a precise weight of the ball 100. In some examples, by adjusting the precise weight of the ball 100, the rolling capabilities of the ball 100 on a surface onto which it is thrown or rolled can be adjusted.

In some examples, the amount of solid material 130 is selected such that the overall weigh of the ball 100 is approximately 250 grams, such as, for example, 250 grams. In some examples, by adjusting the weight, the ability of the ball 100 to stop appropriately on various surfaces, whether flat, inclined, or declined, can be adjusted.

In some examples, the filter portion 104 prevents solid material 130 from entering or exiting the interior cavity 118 of the ball 100. In some examples, the filter portion 104 permits passive diffusion of gaseous material 132 into and out of the interior cavity 118 of the ball 100. In some examples, when the ball 100 is in an inflated state with gaseous material 132 therein, as a user squeezes the ball 100 gaseous material 132 is forced through the bottom hole 11c6 of the sleeve 110, through the filter portion 104, out of the hole 108, and out of the ball 100 such that the ball 100 is placed into a deflated state. In some examples, after the ball is placed into the deflated state, as the ball 100 is released by a user gaseous material 132 is permitted to diffuse back through the hole 108, through the filter portion 104, through the bottom hole 116 and into the interior cavity 118 of the ball 100, thereby causing the ball to be placed back into the inflated state. In some examples, the filter portion 104 may be selected as to allow gaseous material 132 to more slowly or rapidly travel through the filter portion 104, thereby increasing or decreasing the amount of time that it takes for the ball 100 to switch between in inflated state and deflated state. In some examples, using the filter portion 104 with the ball 100, over inflation of the ball 100 with gaseous material 132 is avoided.

In some examples, the filter portion 104 comprises a mechanical switch in the filter portion 104 that activates under pressure, allowing for selective control over gaseous material 132 and solid material 130 entering and exiting the interior cavity 118 of the ball 110. In some examples, the filter portion 104 comprises a two way valve that activates with air pressure.

In some examples, using the concepts of the present disclosure, the adaptability of the ball 100 in different settings is increased. In some examples, by providing various colors on the outer surface 106 of the ball 100, easy identification and use in competitive or team-based activities is facilitated. In some examples, the ability to adjust the weight and behavior of the ball 100 on various surfaces offers a tailored experience, enhancing gameplay and therapeutic practices.

In some examples, using the concepts of the present disclosure, the ball 100 can be used indoors or outdoors or in water. In some examples, the ball 100 is adaptable for juggling. In some examples, the ball 100 can be used as a projectile in various games, such as, for example, the example games described in U.S. patent application Ser. No. 18/640,753, filed on Apr. 19, 2024, the entirety of which is hereby incorporated by reference.

In some examples, the ball 100 can be used in other example games, such as games in which players to establish their own targets on any surface at any distance. In such games, success requires subsequent players to replicate the initial ball placement from the same distance.

In some examples, the ball 100 can be used in other example games, such as, for example, in a skill-based game where players navigate through a course by rolling or throwing the ball 100 through various targets. The winner is determined by the fewest rolls or throws required to complete the course.

In some examples, the weight of the ball 100 is selected to suit different needs, such as, for example, physical therapy or game difficulty adjustments. In some examples, these applications may influence how much the ball 100 is desired to roll before stopping. Likewise, in some examples, the weight of the ball 100 is selected to accommodate different inclines and playing conditions in which the ball 100 is used.

In some examples, the filter portion 104 extends a first distance into the interior space of the ball 100. In some examples, the first distance is selected to improve the amount of gaseous transmission between the interior cavity 118 of the ball 100 and an outside environment, while maintaining desirable playing characteristics. In some examples, the first distance is less than approximately one half of the diameter of the ball 100. In some examples, the first distance is approximately one third of the diameter of the ball 100. In some examples, the first distance is greater than one quarter of the diameter of the ball 100.

### Methods and Systems of Manufacturing

In some examples, the ball 100 is manufactured using a step by step process. In some examples, the process comprises filling the shell portion 102 with solid material 130 and subsequently inserting the filter portion 104 into the shell portion 102. In some examples, various systems are utilized in order to facilitate the manufacture of the ball 100.

In some examples, a filling station is utilized to facilitate filling of the shell portion 102 of the ball 100 with solid material 130. In some examples, the filling station, provides mechanical agitation to the solid material 130 to more efficiently and quickly fill the shell portion 102 of the ball 100 with solid material.

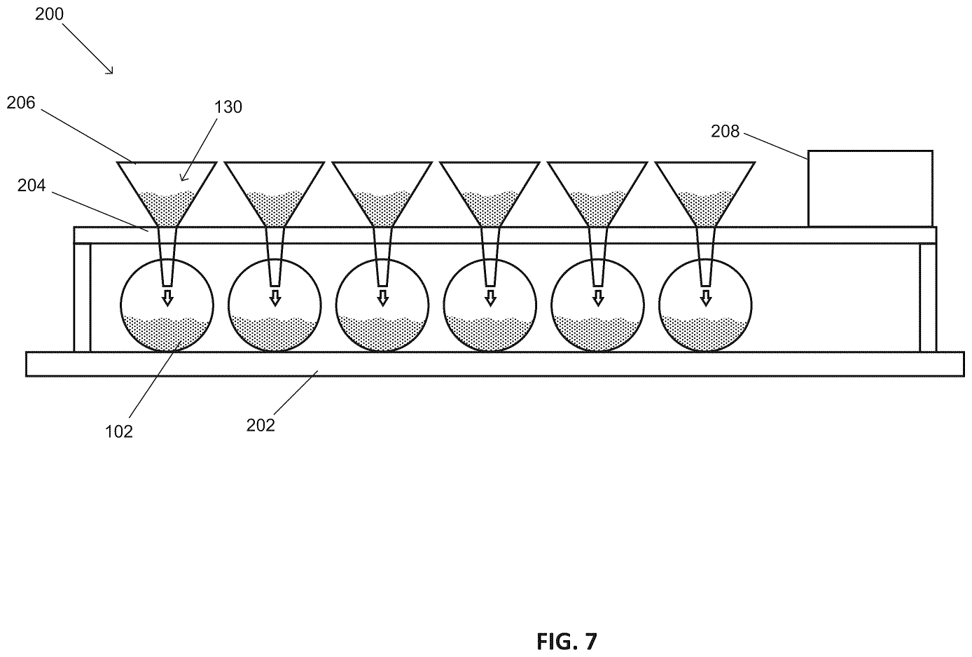

FIG. 7 is a schematic view of an example filling station utilized to facilitate filling the shell portion 102 of the ball 100 with solid material 130. In some examples, the system 200 comprises a support surface 202, an upper plate 204, one or more funnels 206, and a motor 208.

In some examples, the system 200 comprises multiple funnels 206 such that multiple shell portions 102 can be filled by the system 200 at once.

In some examples, the support surface 202 is a surface upon which the system 200 is arranged. In some examples, one or more shell portions 102 are arranged on the support surface 202 for filling. In some examples, the shell portions 102 are arranged in a line along the support surface.

In some examples, the upper plate 204 is formed with multiple holes arranged therein. In some examples, the upper plate 204 is arranged over the one or more shell portion 102 such that one hole is arranged over each shell portion 102.

In some examples, one or more funnels 206 are arranged within the upper plate 204. In some examples, each funnel 206 comprises a funnel stem and a funnel bowl. In some examples, the funnel stem of each funnel 206 is inserted through one of the holes formed in the upper plate 204. In such examples, when inserted into the holes in the upper plate 204, the funnel bowls of each respective funnel 206 rest on the upper plate 204 and prevent the funnel 206 from slipping further through each of the holes in the upper plate 204.

In some examples, each of the funnel stems are inserted into the hole 108 in each of the shell portions 102 arranged in the system 200. In some examples, each of the funnel stems are further inserted into the sleeve 110 of the shell portions 102. In some examples, the use of the funnels 206 with the shell portions 102 provides a wider opening into the sleeve 110.

In some examples, after the funnel stems are inserted into the holes 108 of the shell portions 102, solid material 130 is inserted into the funnel bowls of each respective funnel 206.

In some examples, depending on the type of solid material 130, the solid material 130 may freely flow along a flow path from the funnel bowl into the funnel stem, through the sleeve 110 and bottom hole 116 of the shell portion 102 into the interior cavity 118 (labeled in FIG. 3). In other examples, the solid material 130 may clump up in the flow path and form blockages, thereby preventing or slowing the filling process of the shell portion 102 with solid material 130.

In some examples, a motor 208 is provided on the upper plate 204 of the system 200. In some examples, the motor 208 is configured to provide mechanical vibrations along the upper plate 204 which are transmitted through the upper plate 204 to the funnels 206 and the shell portions 102. In some examples, such vibrations cause the clumps of solid material 130 to break up, thereby minimizing the blockages along the flow path of solid material 130 into the interior cavity 118 of the shell portion 102.

In some examples, once a desired amount of the solid material 130 is inserted into the shell portion 102, the funnels 206 may be kept within the holes 108 of the shell portion 102 to facilitate the insertion of the filter portion 104 into the sleeve 110 of the shell portion. In some examples, a filter portion 104 is inserted into the funnel bowl and pressed through the funnel stem into the sleeve 110 of the shell portion 102. In some examples, once the filter portion is fully inserted into the sleeve 110, the funnel stem of the funnel 206 is removed from the hole 108.

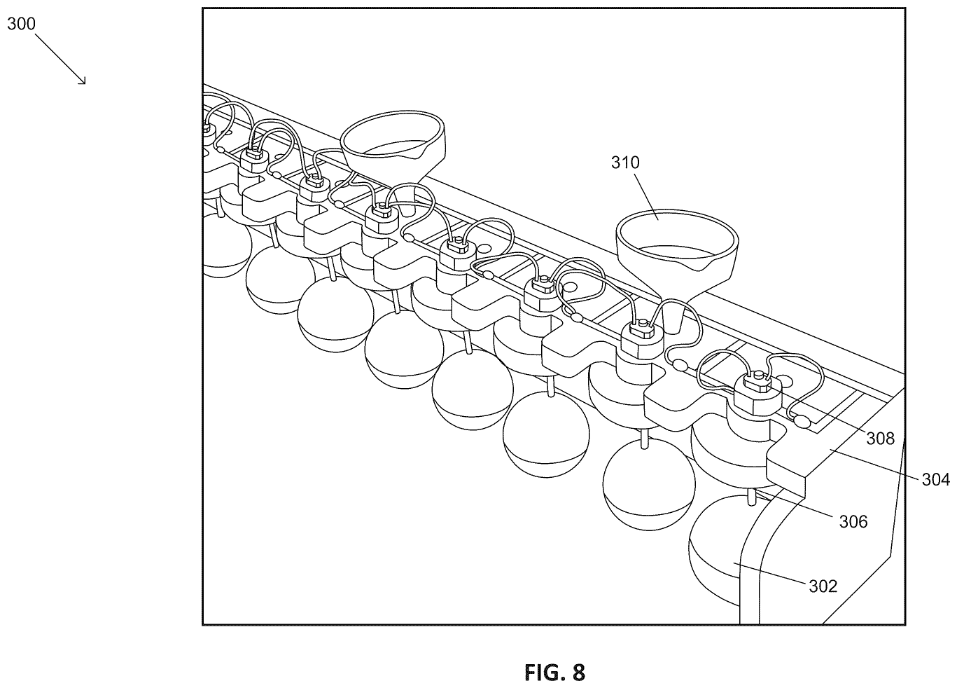

FIG. 8 is a perspective view of another example filling station system 300 utilized to facilitate filling the shell portion 102 of the ball 100 with solid material 130. In some examples, the system 300 is similar in many aspects to the system 200. In some examples, the system 300 comprises a support surface 302, an upper plate 304, one or more funnels 306, and a motor 308. In some examples, the system 300 further comprises one or more backup funnels 310 that may be utilized to provide additional solid material 130 to funnels 306.

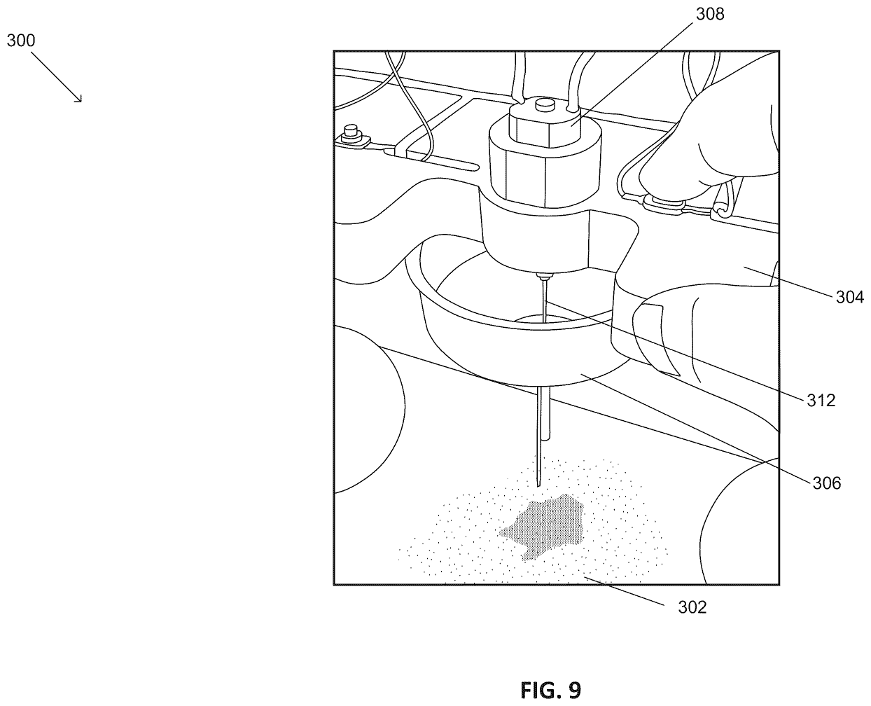

FIG. 9 is a detail view of a portion of the example system 300. As shown in FIG. 9, in some examples, the upper plate 304 is arranged over the support surface 302 with the funnel 306 arranged underneath the upper plate 304. In some examples, a motor 308 is arranged over each funnel 306 included in the example filling station. In some examples, the motor 308 includes a rod 312 extending therefrom. In some examples, the rod 312 is configured to extend from the motor 308, through the funnel 306 such that the rod 312 extends through a funnel bowl and a funnel stem of the funnel 306. In some examples, the rod 312 includes a curved end that extends out from the end of the funnel stem of the funnel 306. In some examples, the motor 308 is selectively operable to cause the rod 312 to rotate. In other examples, the rod 312 does not include a curved end and is substantially straight along its length. In some examples, the rod 312 does not extend from the end of the funnel stem of the funnel 306 and instead terminates within the funnel stem.

In some examples, a shell portion 102 is able to be inserted into the example system 300 by inserting the funnel stem of the funnel 306 into the hole 108 of the shell portion 102. In some examples, inserting the shell portion 102 into the system 300 further comprises inserting the rod 312 through the hole 108 of the shell portion 102. In some examples, inserting the shell portion 102 into the system 300 further comprises inserting the rod 312 through the bottom hole 116 of the sleeve 110 of the shell portion 102.

In some examples, once the shell portion 102 is inserted into the system 300, the motor 308 is powered to cause the rod 312 to rotate. In some examples, the rotation of the rod 312 causes any clumps of solid material 130 to be broken up and minimizes the formation of blockages in a flow path between the funnel bowl and interior cavity 118 of the shell portion 102.

In some examples, utilizing either of the systems 200, 300, expedites and streamlines the process of filling the shell portions 102 with solid material 130, thereby providing enhanced efficiency and uniformity.

### Game Board Accessories

In some examples, the ball 100 may be utilized for playing a variety of games, such as, for example, the example games described in U.S. patent application Ser. No. 18/640,753. In other examples, the ball 100 may be utilized for other games, such as, for example, games in which projectiles (such as, for example, bean bags) are thrown by users onto a surface of a game board.

In some examples, the ball 100 is optimized for play using a game board surface having a particular angle with respect to a horizontal plane (a plane having a surface perpendicular to the direction of the force of gravity). In some examples, the particular angle is approximately 5 degrees, such as, for example, 5 degrees. The present disclosure is further directed to an example game board accessory for modifying the angle of the game board surface with respect to the horizontal plane such that the game board can be optimized for use with a particular projectile, such as, for example, the ball 100.

In some examples, the game board accessory allows for a game board surface to be oriented at a particular angle with respect to the horizontal plane regardless of the game board shape, game environments, and/and surface conditions. In some examples, when utilizing a game board with the ball 100 of the present disclosure, by modifying the particular angle of the game board surface with respect to the horizontal, a user can optimize the game board to increase the speed in which the ball 100 halts when landing on the game board surface.

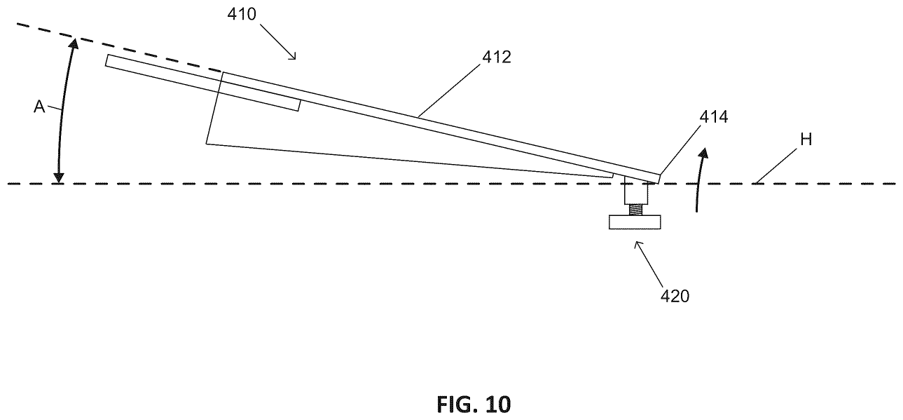

FIG. 10 is a side view of an example game board 410 equipped with an example game board accessory 420. In some examples, the game board 400 is substantially similar to the game board 100 or 200 described in U.S. patent application Ser. No. 18/640,753. In some examples, the game board 400 is substantially similar to a game board used to play cornhole.

In some examples, the game board 410 includes a game board surface 412 and a front end 414. In some examples, when arranged on a support surface, the game board surface 412 is oriented at an angle A from the horizontal plane H.

In some examples, the angle A is able to be decreased using the game board accessory 420. In some examples, the game board accessory 420 is attached to a front end of the game board 410. In some examples the game board accessory 420 is attached to the front end of the game board 410 utilizing a bracket. In some examples, the game board accessory 420 comprises one or more bolts which may be rotated in and out of the game board accessory 420 to increase the height of the game board accessory 420. In some examples, by increasing the height of the game board accessory 420, the front end 414 is lifted such that the angle A of the game board surface 412 with respect to the horizontal plane H can be decreased.

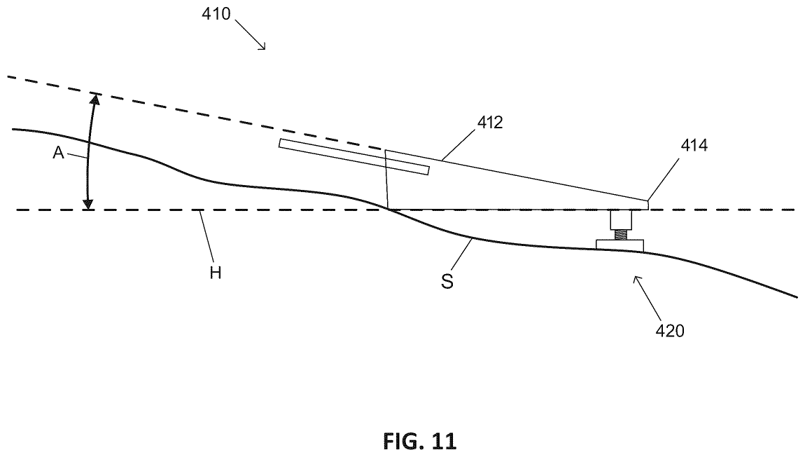

FIG. 11 is another is another a side view of an example game board 410 equipped with an example game board accessory 420 arranged on an inclined playing surface. In the example of FIG. 11, the game board accessory 420 is used to lift the front end 414 of the game board 410 when the game board 410 is placed on an inclined surface

S so that the game board surface 412 is arranged at a desired angle A with respect to the horizontal plane H. In some examples, the game board accessory 420 further comprises a bracket with adjustable feet for contacting the ground. In some examples, the adjustable feet comprise one or more bolts.

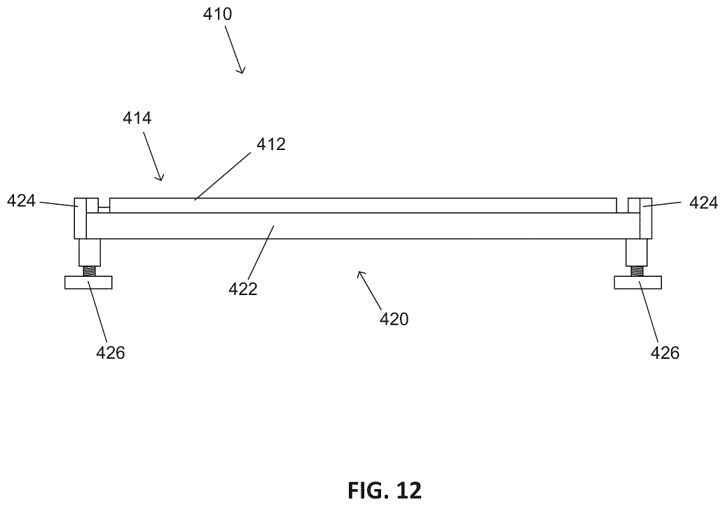

FIG. 12 is a front view of the example game board 410 equipped with the example game board accessory 420. In some examples, the game board accessory comprises a top plate 422, one or more latches 424, and one or more feet 426. In some examples, the top plate 422 provides a surface upon which the game board 410 is placed. In the example of FIG. 12, the bottom surface of the front end 414 is placed onto the top plate 422. In some examples, the top plate 422 extends from a left side of the game board 410 to a right side of the game board 410. In some examples, the latches 424 are arranged on the left side of the top plate 422 and the right side of the top plate 422. In some examples, the latches 424 are configured to releasably secure the game board 410 onto the top plate 422 of the game board accessory 420. In some examples, the latches 424 are configured to contact each of the left and the right side of the game board 410 when the game board 410 is arranged on the top plate 422.

While the game board accessory 420 is described as being attachable to the front end 414 of the game board 410. In other examples, the game board accessory 420 is configured to be attached to the back end of the game board 410 such that the game board accessory 420 can be used to lift the back end of the game board 410 upwards to provide a desired angle for the game board 410. In some examples, the game board accessory 420 is able to be used with a game board 410 without requiring a user to place fasteners into the game board 410 or otherwise damage the game board 410.

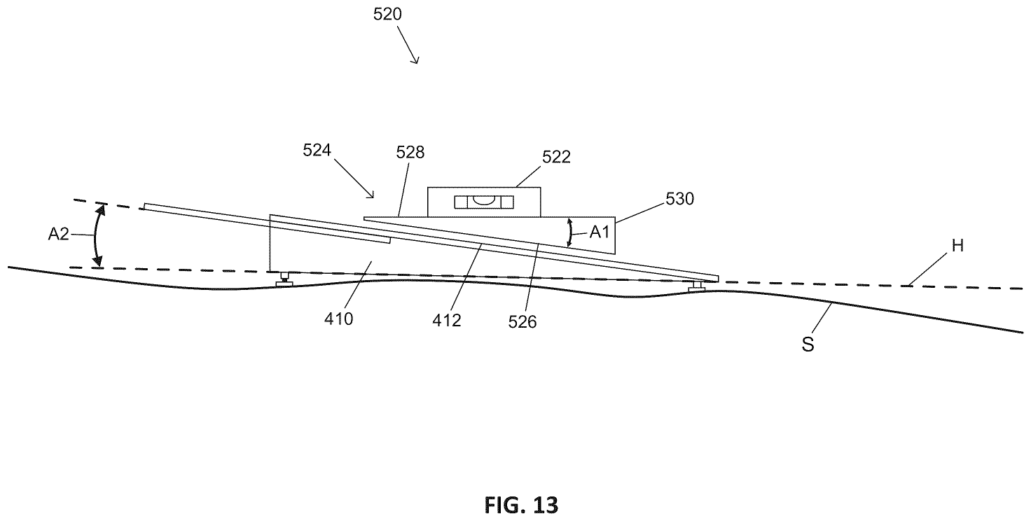

FIG. 13 is a side view of another example game board accessory 520. In some examples, the game board accessory 520 can be used with the example game board 410 and/or the game board accessory 420. In some examples, the example game board accessory 520 comprises a level 522 and a brace 524. In some examples, the game board accessory 520 is used to assist a user in adjusting the angle of the game board surface 412 to an optimal level. In some examples, the optimal level is approximately 5 degrees with respect to the horizontal plane H, such as, for example, 5 degrees with respect to the horizontal plane H.

In some examples, the brace 524 of the game board accessory 520 comprises a slanted edge 526, a straight edge 528, and a vertical edge 530. In some examples, the slanted edge 526, the straight edge 528, and the vertical edge 530 form a right triangle with respect to each other. In some examples, the vertical edge 530 and the straight edge 528 form a 90 degree angle with respect to each other. In some examples, the slanted edge and the straight edge 528 form an angle A1 with respect to each other. In some examples, the slanted edge 526 and the straight edge 538 are connected to each other by a hinge. In some examples, the angle between the slanted edge 526 and the straight edge 528 can be manually adjusted by a user. In such examples, the length of the vertical edge 530 may be adjustable by the user. In other examples, the angle A1 is pre-set by the manufacturer. In some examples, the angle A1 corresponds to a desired angle A2 of the game board surface 412 with respect to the horizontal plane H. In some examples, the angle A1 is approximately 5 degrees, such as, for example, 5 degrees.

In some examples, the level 522 may comprise any one or more different leveling tools, such as, for example, a bubble level or a digital level. In some examples, the level 522 is connected to the straight edge 528 of the brace 524 such that when the straight edge 528 of the brace 524 is parallel with the horizontal plane H, the bubble level indicates an even level measurement.

In some examples, the game board accessory 520 is used by setting the angle A1 between the slanted edge 526 and the straight edge 528 to a desired angle A2 for the game board surface 412 with respect to the horizontal plane H. The brace 524 is then placed onto the game board surface 412 with the slanted edge 526 contacting the game board surface 412 such that the brace 524 extends from near the front end of the game board 410 to near the rear end of the game board 410. In some examples, the user, while referencing the level 522, may adjust the level of the game board 410 either by moving the game board 410 along an irregularly leveled surface S by placing material under the front end of the game board 410 or the rear end of the game board 410, or by using the game board accessory 420. In some examples, the game board accessory 520 remains detached from the game board 510 through the user of the game board accessory 520 such that a user may easily remove the game board accessory 520 once the game board surface 412 is placed at the desired angle A2.

In some examples, when using the game board accessory 520 with the game board accessory 420, the game board surface 412 can be precisely adjusted to a desired angle. In some examples, the desired angle may be achieved even when using the game board 410 on sloped surfaces or when using alternative gaming tops with steeper angles, such as those used in cornhole or bag toss games.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A ball comprising:
a shell portion comprising an outer surface defining an interior space of the ball, and a sleeve extending into the interior space, the sleeve comprising a bottom surface with a hole extending therethrough, the hole providing for communication between an interior cavity of the ball and an outside environment; and
a filter portion arranged within the sleeve, the filter portion permitting airflow between the interior cavity and the outside environment while restricting fluid flow between the interior cavity and the outside environment.

2. The ball of claim 1, wherein the shell portion comprises a non-porous material.

3. The ball of claim 2, further comprising a solid material arranged within the interior cavity.

4. The ball of claim 3, wherein the solid material comprises any one or more of sand, salt, flour, glass, plastic, corn, beans, and magnetic beads.

5. The ball of claim 4, wherein the shell portion comprises a flexible material.

6. The ball of claim 2, wherein the shell portion comprises any one or more of PVC, silicone, silicone rubber, and TPU.

7. The ball of claim 1, wherein the filter portion is arranged over the hole.

8. The ball of claim 1, wherein the filter portion contacts the bottom surface of the sleeve.

9. The ball of claim 1, wherein the filter portion comprises a porous media.

10. The ball of claim 9, wherein the porous media comprises synthetic fiber, polyester (such as, for example, extruded polyester), or foam (such as, for example, open-cell foam).

11. The ball of claim 10, wherein the filter portion is adhesively bonded to the sleeve.

12. The ball of claim 11, wherein the sleeve extends a first distance into the interior space of the ball, and wherein the first distance is less than approximately half of a diameter of the ball.

13. A ball comprising:
a shell portion comprising a flexible outer surface and an inner sleeve, the shell portion defining an inner cavity of the ball;
a solid material arranged within the inner cavity; and
a filter portion arranged in the inner sleeve, the filter portion being configured to permit transmission of gaseous material and block transmission of the solid material into and out of the inner cavity.

14. The ball of claim 13, wherein the solid material comprises any one or more of sand, salt, flour, glass, plastic, corn, and beans.

15. The ball of claim 13, wherein the shell portion comprises any one or more of PVC, silicone, silicone rubber, and TPU.

16. The ball of claim 15, wherein the inner sleeve comprises a bottom surface 114 with a hole arranged therethrough.

17. The ball of claim 16, wherein the filter portion is arranged over the hole.

18. The ball of claim 13, wherein the filter portion is held within the inner sleeve by an interference fit.

19. The ball of claim 18, wherein the inner cavity further comprises a gaseous material.

20. The ball of claim 19, wherein the filter portion comprises a hole that extends into a body of the filter portion through a top surface thereof.
